(19) United States
(12) Patent Application Publication
(10) Pub. No.: US 2025/0327472 A1
(43) Pub. Date: Oct. 23, 2025

(54) TWO-PIECE SEALING PLUGS FOR BLIND HOLE, ONE-SIDED INSTALLATION

(71) Applicant: Avdel UK Limited, Letchworth Garden City (GB)

(72) Inventor: Carl P. HERSANT, Bengeo (GB)

(21) Appl. No.: 18/639,431

(22) Filed: Apr. 18, 2024

(51) Int. Cl. F16B 13/00

(52) U.S. Cl. CPC F16B 13/00; F16B 2013/006

(57) ABSTRACT

A sealing plug for blind hole, one-sided installation includes a stem head having a first end and an opposing second end, where the stem head includes a lip member disposed at the first end and having a first diameter, a skirt member disposed at the second end and have a second diameter that is less than the first diameter, and a first tapered portion disposed between the lip member and the skirt member and having a third diameter, a fourth diameter, and a first sloped portion therebetween. The stem head may also include a second tapered portion between the first tapered portion and the skirt member. The second tapered portion may have a fifth diameter, a sixth diameter, and a second sloped portion therebetween. The stem head may also include a waist member between the second tapered portion and the skirt member, the waist member having a seventh diameter.

### FIELD

The present disclosure relates to a two-piece sealing plugs for blind hole, one-sided installation.

### BACKGROUND

This section provides background information related to the present disclosure which is not necessarily prior art.

Two-piece sealing plugs can be installed rapidly into blind holes, helping to eliminate the need to tap threads in various applications. Two-piece sealing plugs often include a stem and a sleeve that surrounds a portion of the stem. Pulling of the stem, for example, using a rivet placing tool may expand the sleeve to securely seal blind holes having a normal drilled surface.

### SUMMARY

This section provides a general summary of the disclosure, and is not a comprehensive disclosure of its full scope or all of its features.

The present disclosure provides a sealing plug for blind hole, one-sided installation.

In at least one example embodiment, the sealing plug may include a stem and a sleeve. The stem may include a stem body and a stem head. The stem head may include a first portion and a second portion, where the first portion is a tapered portion having a first diameter, a second diameter that is less than the first diameter, and a first sloped portion therebetween, and the second portion has a third diameter that is less than the first and second diameters. The sleeve may surround at least a portion of the stem head.

In at least one example embodiment, the first portion may be a first tapered portion, and the stem head may further include a second tapered portion that is between the first tapered portion and the second portion. The second tapered portion may have a fourth diameter, a fifth diameter that is less than the fourth diameter, and a second sloped portion therebetween.

In at least one example embodiment, the stem head may have a first length, the first tapered portion may have a second length greater than or equal to about 36% to less than or equal to about 44% of the first length, the second portion may have a third length greater than or equal to about 7% to less than or equal to about 14% of the first length, and the second tapered portion may have a fourth length greater than or equal to about 11% to less than or equal to about 16% of the first length.

In at least one example embodiment, the third diameter may be less than each of the first diameter, the second diameter, and the fourth diameter.

In at least one example embodiment, the third diameter is the same as fifth diameter.

In at least one example embodiment, the stem head may include a first end and an opposing second end, where the second end of the stem head is disposed nearer to the stem body than the first end of the stem head. The stem head may include a lip member disposed at the first end of the stem head and connected to the first portion. The lip member may have a fourth diameter greater than a remainder of the stem head, where the remainder of the stem head includes the first portion and the second portion.

In at least one example embodiment, the stem head may include a first end and an opposing second end, where the second end of the stem head is disposed nearer to the stem body than the first end of the stem head. The stem head may include a skirt member disposed at the second end of the stem head and connected to the second portion. The skirt member may have a flap separated from a body of the stem head and that extends around at least a portion of the second end of the stem head.

In at least one example embodiment, the sleeve may have a first length greater than or equal to about 13.7% to less than or equal to about 14.5% of a second length of the stem.

In at least one example embodiment, the sealing plug is an all-aluminum sealing plug, the stem and sleeve each including an aluminum alloy.

In at least one example embodiment, at least one of the stem and the sleeve includes aluminum grades 6061, 3103, 7075, or any combination thereof.

In at least one example embodiment, the stem may have a first hardness that is greater than a second hardness of the sleeve.

In at least one example embodiment, the sleeve may have a first ductility that is greater than a second ductility of the stem.

In at least one example embodiment, the stem body may have a fourth diameter that is less than the third diameter, the stem may further include a breaker groove between the stem head and the stem body, and the breaker groove may have a fifth diameter that is less than the both the third diameter and the fourth diameter.

In at least one example embodiment, the sleeve may have a central bore having a first section, a second section, and a middle section disposed therebetween. The first section may have a fourth diameter. The second section may have a fifth diameter that is the same as or different from the fourth diameter. The middle section may have a sixth diameter that is greater than both the fourth diameter and the fifth diameter.

In at least one example embodiment, the sleeve may have a first end and an opposing section end, where the second end of the sleeve is disposed nearer to the stem body than the first end of the sleeve. The sleeve may have a chamfered portion disposed at the first end of the sleeve. The chamfered portion may be angled inward toward the central bore of the sleeve.

In at least one example embodiment, the chamfered portion may have a first length that is greater than or equal to about 18% to less than or equal to about 24% of a second length of the sleeve.

In at least one example embodiment, the stem body may include a plurality of threads. The plurality of threads may extend along greater than or equal to about 60% to less than or equal to about 95% of a length of the stem body.

In at least one example embodiment, the first portion may be a first tapered portion, the stem body may have a first end and an opposing second end, and the first end of the stem body may be disposed nearer to the stem head than the second end of the stem body. The stem body may include a first thread-free portion disposed at the first end of the stem body and a second thread-free portion disposed at the second end of the stem body. The second thread-free portion may be a second tapered portion that includes a fourth diameter, a fifth diameter that is less than the fourth diameter, and a second sloped portion therebetween.

In at least one example embodiment, the stem head may have a first length greater than or equal to about 15% to less than or equal to about 18% of a second length of the stem body.

The present disclosure provides a sealing plug for blind hole, one-sided installation.

In at least one example embodiment, the sealing plug includes a stem head having a first end and an opposing second end, where the stem head includes a lip member disposed at the first end and having a first diameter, a skirt member disposed at the second end and have a second diameter that is less than the first diameter, and a tapered portion disposed between the lip member and the skirt member and having a third diameter, a fourth diameter that is less than the third diameter, and a first sloped portion therebetween. The third and fourth diameters may be less than the first diameter and greater than the second diameter.

In at least one example embodiment, the tapered portion may be a first tapered portion, and the stem head may further include a second tapered portion between the first tapered portion and the skirt member. The second tapered portion may have a fifth diameter, a sixth diameter that is less than the fifth diameter, and a second sloped portion therebetween. The fifth and sixth diameters may be less than the third and fourth diameter and greater than the second diameter.

In at least one example embodiment, the stem head may further include a waist member between the second tapered portion and the skirt member. The waist member may have a seventh diameter that is same as the second diameter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a front perspective view of an example sealing plug in accordance with at least one example embodiment of the present disclosure;

FIG. 1B is a rear perspective view of the example sealing plug in accordance with at least one example embodiment of the present disclosure;

FIG. 2 is a side view of a stem member of the example sealing plug illustrated in FIGS. 1A and 1B;

FIG. 3 is a side view of a sleeve member of the example sealing plug illustrated in FIGS. 1A and 1B;

FIG. 4 is a cross-sectional view of the example sealing plug illustrated in FIGS. 1A and 1B;

FIG. 5A is a perspective view of another example sealing plug including a sleeve member that receives a stem member, like the stem member illustrated in FIG. 2, in accordance with at least one example embodiment of the present disclosure;

FIG. 5B is a cross-sectional view of the example sealing plug illustrated in FIG. 5A;

FIGS. 6A-6D are cross-sectional views that illustrate a process for sealing a blind hole using an example sealing plug in accordance with at least one example embodiment of the present disclosure.

Corresponding reference numerals indicate corresponding parts throughout the several views of the drawings.

### DETAILED DESCRIPTION

Example embodiments will now be described more fully with reference to the accompanying drawings.

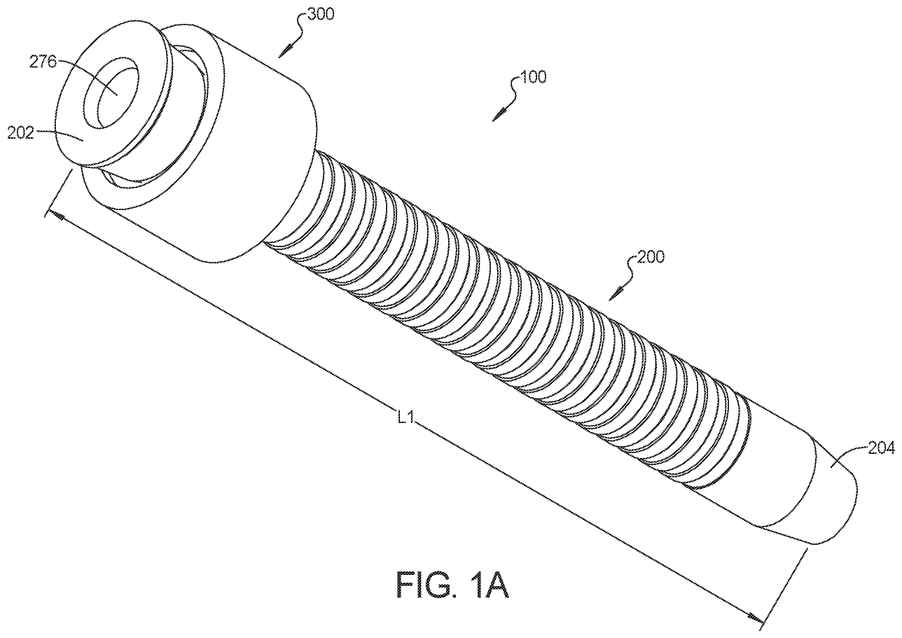

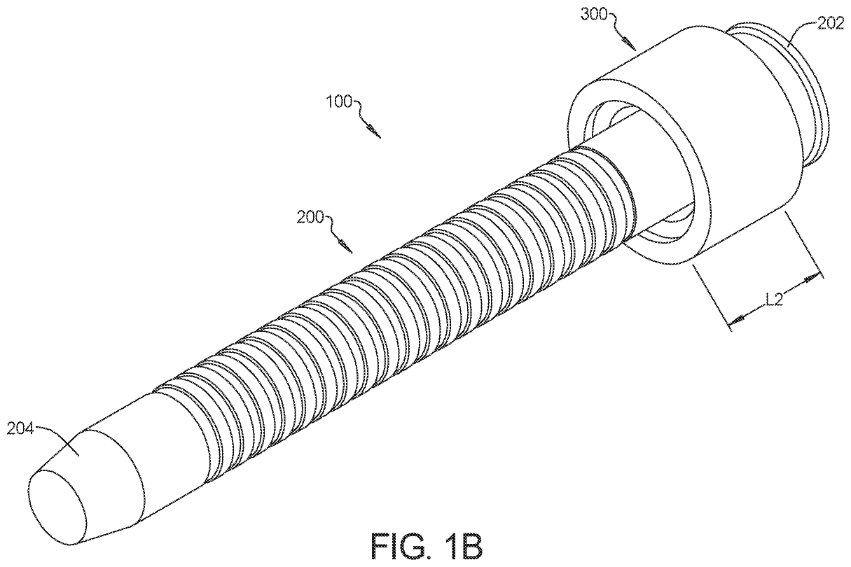

FIG. 1A is a front perspective view of an example sealing plug 100.

FIG. 1B is a rear perspective view of the example sealing plug 100. The sealing plug 100 is a two-piece (or two-part) sealing plug including, for example, a stem 200 and a sleeve 300, where the sleeve 300 is configured to surround at least a portion of the stem 200. For example, the stem 200 may include a first end (or portion or region) 202 and an opposing second end (or portion or region) 204 and the sleeve 300 may surround, as illustrated, at least a portion of the first end 202 of the stem 200 or at least a portion near the first end 202 of the stem 200. In at least one example embodiment, the sleeve 300 may have a length (L2) greater than or equal to about 13.7% to less than or equal to about 14.5%, and optionally greater than or equal to about 13.74% to less than or equal to about 14.41%, of a length (L1) of the stem 200. In at least one example embodiment, the length (L1) of the stem 200 from the first end 202 to the second end 204 is greater than or equal to about 45.1 millimeters to less than or equal to about 45.8 millimeters, optionally greater than or equal to about 45.14 millimeters to less than or equal to about 45.75 millimeters, and optionally greater than or equal to about 45.27 millimeters to less than or equal to about 45.62 millimeters. In at least one example embodiment, the length (L2) of the sleeve 300 is greater than or equal to about 6.2 millimeters to less than or equal to about 6.6 millimeters, optionally greater than or equal to about 6.2 millimeters to less than or equal to about 6.56 millimeters, and optionally greater than or equal to about 6.33 millimeters to less than or equal to about 6.43 millimeters.

The sealing plug 100 may be an all-aluminum sealing plug. For example, in at least one example embodiment, the stem 200 and the sleeve 300 may include, for example, aluminum grades 6061, 3103, 7075, or any combination thereof. The stem 200 and sleeve 300 may include the same or different aluminum alloy. The stem 200 has a first hardness that is greater than a second hardness of the sleeve 300, while the sleeve 300 has a first ductility that is greater than a second ductility of the stem 200. For example, in at least one example embodiment, the stem 200 may have a Vickers hardness of about 100 and/or an ultimate tensile strength of about 300 MPa, and the sleeve 300 may have a Vickers hardness of about 40 and/or an ultimate tensile strength of about 120 MPa. In at least one example embodiment, the sleeve 300 is prepared using one or more fully annealed aluminum alloys, while the stem 200 is prepared using one or more heat treated aluminum alloys. The sleeve 300 maintains some ductility to provide certain sealing benefits, such as those detailed below.

In various aspects, the aluminum construction of the sealing plug 100 may help to eliminate red rust that may be experienced, for example, when steel stems are used. Further, in at least one example embodiment, when an all-aluminum sealing plug is installed in, or used with, a typical aluminum casting (e.g., internal combustion engine block, gearbox, electrified vehicle motor), the all-aluminum sealing plug will have a similar thermal expansion rate as the application metal during various heating and cooling events, thereby reducing possible dimensional changes that might compromise the sealing performance of the sealing plug. Further still, in at least one example embodiment, using an aluminum stem may allow corrosion protective coatings, like electroplated zinc, to be omitted. Corrosion protective coatings often flake at a gripping point accumulating to clog equipment, eventually requiring disassembly and cleaning. Further still, in at least one example embodiment, all-aluminum sealing plugs may be lighter than sealing plugs including steel stems, helping to reduce wear and tear on equipment for inserting the all-aluminum sealing plugs, like tool pulling jaws and nose tips. Further still, in at least one example embodiment, all-aluminum sealing plugs may be easier to cold form.

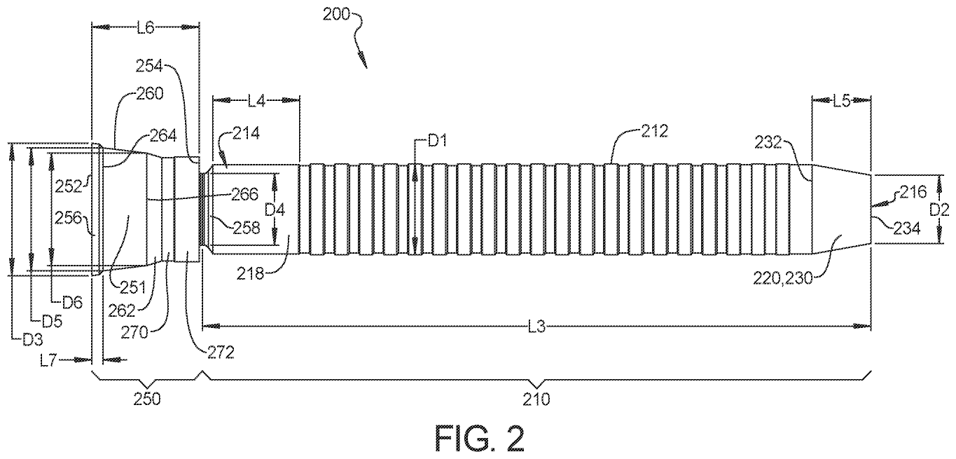

FIG. 2 is a side view of the stem 200. The stem 200 includes a stem body 210 including a plurality of threads, or pintail pull grooves, 212. The stem body 210 has a first end 214 and an opposing second end 216. In at least one example embodiment, a length (L3) of the stem body 210 from the first end 214 to the second end 216 may be greater than or equal to about 38.7 millimeters to less than or equal to about 39.4 millimeters, optionally greater than or equal to about 38.74 millimeters to less than or equal to about 39.25 millimeters, and optionally greater than or equal to about 38.87 millimeters to less than or equal to about 39.12 millimeters. In at least one example embodiment, the stem body 210 may be generally cylindrical. The stem body 210 may have an average diameter (D1) greater than or equal to about 4.5 millimeters to less than or equal to about 6.5 millimeters, greater than or equal to about 4.9 millimeters to less than or equal to about 6.3 millimeters, optionally less than or equal to about 4.96 millimeters to less than or equal to about 6.27 millimeters, optionally greater than or equal to about 5.09 millimeters to less than or equal to about 6.14 millimeters, and optionally about 5 millimeters. The larger diameter of the stem body 210 may help to provide further stability to the stem 200 when manipulated by equipment, like tool pulling jaws and nose tips. The larger diameter stem body 210 may be less liable to unwanted bending in subsequent manufacturing processes and assembly, including various heat treatments.

The threads 212 may extend along only a portion of the stem body 210, while portions of the stem body 210 near the first and second ends 214, 216 are free of threads, and in at least one example embodiment, substantially smooth. In at least one example embodiment, the threads 212 may extend along greater than or equal to about 60% to less than or equal to about 95%, greater than or equal to about 70% to less than or equal to about 90%, and optionally greater than or equal to about 75% to less than or equal to about 85%, of the length (L3) of the stem body 210. In at least one example embodiment, a first thread-free portion 218 of the stem body 210 near the first end 214 may have a length (L4) greater than or equal to about 4.8 millimeters to less than or equal to about 5.3 millimeters, optionally greater than or equal to about 4.89 millimeters to less than or equal to about 5.25 millimeters, and optionally greater than or equal to about 5.02 millimeters to less than or equal to about 5.12 millimeters. In at least one example embodiment, a second thread-free portion 220 of the stem body 210 near the second end 216 may have a length (L5) greater than or equal to about 3.2 millimeters to less than or equal to about 3.6 millimeters, optionally greater than or equal to about 3.3 millimeters to less than or equal to about 3.56 millimeters, and optionally about 3.43 millimeters.

The second end 216 of the stem body 210 may include a tapered portion (or region) 230. In at least one example embodiment, the tapered portion 230 may be the same as the second thread-free portion 220. The tapered portion 230 has a first end (or portion or region) 232 having a first diameter and an opposing second end (or portion or region) 234 having a second diameter that is less than the first diameter. The tapered portion 230 is sloped between the first end 232 and the second end 234. Although the tapered portion 230 is illustrated as having a sloped portion, it should be appreciated that, in various other example embodiment, the tapered portion 230 may include a curved portion.

In at least one example embodiment, the first end 232 of the tapered portion 230 may continue from the threaded portion of the stem body 210. That is, the first end 232 of the tapered portion 230 may have diameter (D1), while the second end 234 of the tapered portion 214 has a diameter (D2) greater than or equal to about 3.7 millimeters to less than or equal to about 4.3 millimeters. The tapered portion 230 may help to aid with the placement of the stem body 210 within equipment for insertion or installation, like tool pulling jaws and nose tips.

The stem 200 further includes a stem head (or sealing heat) 250 attached or coupled to the first end 214 of the stem body. The stem head 250 may be coupled to the first thread-free portion 218 of the stem body 210. In at least one example embodiment, the stem head 250 may have a length (L6) greater than or equal to about 6.2 millimeters to less than or equal to about 6.7 millimeters, optionally greater than or equal to about 6.27 millimeters to less than or equal to about 6.63 millimeters, and optionally greater than or equal to about 6.4 millimeters to less than or equal to about 6.5 millimeters. In at least one example embodiment, the length (L6) of the stem head 250 may be greater than or equal to about 15% to less than or equal to about 18%, and optionally greater than or equal to about 16% to les than or equal to about 17%, of the length (L3) of the stem body 210. The shorter stem head 200 may be easier to manufacture by cold-forming than comparatively longer stem heads because there is less material deformation.

The stem head 250 has a first end (or portion or region) 252 and an opposing second end (or portion or region) 224, where the first end 252 of the stem head 250 includes a lip 256, and the second end 254 of the stem head 250 is coupled to the first end 214 of the stem body 210 via a breaker groove 258.

The lip 256 may be configured to halt movement of the stem 200, for example, at the end of a placing stroke, as the stem 200 is pulled through a central bore 302 of the sleeve 300 for sealing, such as further discussed below. For example, the lip 256 may have an average diameter (D3) greater than the remainder of the stem head 220. In at least one example embodiment, the lip 256 may have an average diameter (D3) greater than or equal to about 7.5 millimeters to less than or equal to about 7.9 millimeters, optionally greater than or equal to about 7.57 millimeters to less than or equal to about 7.88 millimeters, and optionally greater than or equal to about 7.7 millimeters to less than or equal to about 7.75 millimeters. In at least one example embodiment, the lip 256 may have a length (L7) greater than or equal to about 0.2 millimeters to less than or equal to about 0.6 millimeters, optionally greater than or equal to about 0.24 millimeters to less than or equal to about 0.6 millimeters, and optionally greater than or equal to about 0.37 millimeters to less than or equal to about 0.47 millimeters. In at least one example embodiment, the lip 256 may have a slightly sloped, or tapered, or curved, configuration, where an outer (or first) end (or portion or region) of the lip 256 has a first diameter and an opposing inner (or second) end (or portion or region) of the lip 256 has a second diameter that is less than the first diameter.

The breaker groove 258 is the point at which the stem body 210 disconnects, or disassociates, with the stem head 220 after placement, such as further discussed below. The breaker groove 258 may have an average diameter that is less than both the diameter (D1) of the stem body 210 and the diameters (D3, D4, D5, D6, D7, D8, D9) of the stem head 250. For example, the breaker groove 240 may have an average diameter (D4) greater than or equal to about 4 millimeters to less than or equal to about 4.4 millimeters, optionally greater than or equal to about 4.05 millimeters to less than or equal to about 4.36 millimeters, and optionally greater than or equal to about 4.18 millimeters to less than or equal to about 4.23 millimeters.

The stem head 250 is sloped (or tapered) between the lip 256 and the breaker groove 258. In at least one example embodiment, as illustrated, the stem head 250 may include a first tapered portion (or region) 260 and a second tapered portion (or region) 262, where the first tapered portion 260 extends between the lip 256 and the second tapered portion 262, and the second tapered portion 262 is disposed between the first tapered portion 260 and the breaker groove 258.

The first tapered portion 260 may have an outer (or first) end (or portion or region) 264 having a first diameter (D5) and an opposing inner (or second) end (or portion or region) 266 having a second diameter (D6) that is less than the first diameter (D5) of the first end 264. The first tapered portion 260 may be sloped between the first end 264 and the second end 266. Although the first tapered portion 260 is illustrated as having a sloped portion, it should be appreciated that, in various other example embodiment, the tapered portion 230 may include a curved portion.

In at least one example embodiment, the diameter (D5) of the first end 264 of the first tapered portion 260 may be greater than or equal to about 7 millimeters to less than or equal to about 7.4 millimeters, and the diameter (D6) of the second end 266 of the first tapered portion 260 may be greater than or equal to about 6.4 millimeters to less than or equal to about 6.7 millimeters. In at least one example embodiment, the first tapered portion 260 may have a length (L8) between the first end 264 and the second end 266 of greater than or equal to about 2.3 millimeters to less than or equal to about 2.9 millimeters, optionally greater than or equal to about 2.4 millimeters to less than or equal to about 2.8 millimeters, and optionally about 2.6 millimeters. In at least one example embodiment, the length (L8) of the first tapered portion 260 may be greater than or equal to about 36% to less than or equal to about 44%, optionally greater than or equal to about 37% to less than or equal to about 43.5%, and optionally greater than or equal to about 37.09% to less than or equal to about 43.28%, of the length (L6) of the stem head 250.

The second tapered portion 262 may have an outer (or first) end (or portion or region) near the first tapered portion 260 having a first diameter (D7) and an opposing inner (or second) end (or portion or region) nearer to the breaker groove 258 having a second diameter (D8) that is less than the first diameter of the first end. The first diameter (D7) of the first end of the second tapered portion 262 is less than the second diameter (D6) of the first tapered portion 260. The second tapered portion 262 may be sloped between the first end and the second end. Although the second tapered portion 262 is illustrated as having a sloped portion, it should be appreciated that, in various other example embodiment, the tapered portion 230 may include a curved portion.

In at least one example embodiment, the diameter (D7) of the first end of the second tampered portion 262 may be greater than or equal to about 6.4 millimeters to less than or equal to about 6.8 millimeters, optionally greater than or qual to about 6.42 millimeters to less than or equal to about 6.73 millimeters, and optionally greater than or equal to about 6.55 millimeters to less than or equal to about 6.6 millimeters. In at least one example, the diameter (D8) of the second end of the second tampered potion 262 may be greater than or equal to about 5.8 millimeters to less than or equal to about 6.2 millimeters, optionally greater than or equal to about 5.88 millimeters to less than or equal to about 6.19 millimeters, and optionally greater than or equal to about 6.01 millimeters to less than or equal to about 6.06 millimeters. In at least one example embodiment, the second tapered portion 262 may have a length (L9) between the first end and the second end of be greater than or equal to about 0.8 millimeters to less than or equal to about 1 millimeter. In at least one example embodiment, the length (L9) of the second tapered portion 262 may be greater than or equal to about 11% to less than or equal to about 16%, optionally greater than or equal to about 12% to less than or equal to about 15%, and optionally greater than or equal to about 12.9% to less than or equal to about 14.9%, of the length (L6) of the stem head 250.

The stem head 250 may include a waist 270 and a locking skirt 272, where the waist 270 extends between the second tapered portion 262 and the locking skirt 272, and the locking skirt 272 extends between the waist 270 and the breaker groove 258.

The waist 270 may have an average diameter that is the same as the diameter (D8) of the second end of the second tampered portion 262. For example, the waist 270 may have an average diameter (D9) greater than or equal to about 5.8 millimeters to less than or equal to about 6.2 millimeters, optionally greater than or equal to about 5.88 millimeters to less than or equal to about 6.19 millimeters, and optionally greater than or equal to about 6.01 millimeters to less than or equal to about 6.06 millimeters. In at least one example embodiment, the waist 270 may have a length (L10) greater than or equal to about 0.5 millimeters to less than or equal to about 0.9 millimeters, optionally greater than or equal to about 0.55 millimeters to less than or equal to about 0.86 millimeters, and optionally greater than or equal to about 0.68 millimeters to less than or equal to about 0.73 millimeters. In at least one example embodiment, the length (L10) of the waist 270 may be greater than or equal to about 7% to less than or equal to about 14%, and optionally greater than or equal to about 8% to less than or equal to about 13.5%, and optionally greater than or equal to about 8.06% to less than or equal to about 13.43%, of the length (L6) of the stem head 250. In at least one example embodiment, the length (L10) of the waist 270 may be greater than or equal to about 21% to less than or equal to about 32%, and optionally greater than or equal to about 21.7% to less than or equal to about 31.03%, of the length (L8) of the first tapered portion 260.

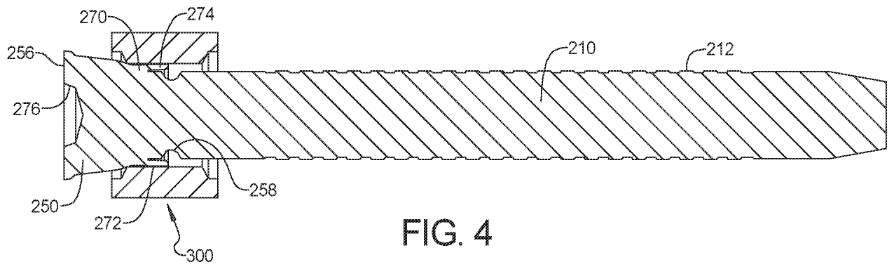

FIG. 4 is a cross-sectional view of the two-piece sealing plug 100. As best illustrated, for example, in FIG. 4, the locking skirt 272 includes a flap 274 that can engage with the sleeve 300, such as further discussed below. The flap 274 may be a continuous flap that is at least partially separated from a body of the stem head 250 that extends around the second end 254 of the stem head 250 before the breaker groove 258 and/or around at least a portion of the breaker groove 258. For example, the flap may extend around greater than or equal to about 95%, optionally greater than or equal to about 96%, optionally greater than or equal to about 97%, optionally greater than or equal to about 98%, optionally greater than or equal to about 99%, optionally greater than or equal to about 99.5%, or optionally greater than or equal to about 99.8%, of a total circumference of the stem head 250. The locking skirt 272 may help to prevent, or limit, recoil of the installed sleeve 300 as the breaker groove 258 disassociates or fractures.

The stem head 250 may include a counterbore 276 that is centrally disposed in the first end 252 of the stem head 250. The counterbore 270 may extend, for example, through the lip 256 and at least a portion of a body 251 of the stem head 250. In at least one example embodiment, the counterbore 278 may have an average diameter (D10) greater than or equal to about 3.6 millimeters to less than or equal to about 4 millimeters, optionally greater than or equal to about 3.62 millimeters to less than or equal to about 3.98 millimeters, and optionally greater than or equal to about 3.75 millimeters to less than or equal to about 3.85 millimeters. The counterbore 270 may help to allow for deformation (e.g., reduction in diameter) of the stem head 250 as it is drawn into the sleeve 300 thereby helping the locking skirt 272 to fully form into the central bore 302 of the sleeve 300, such as further discussed below. The counterbore 270 may also aid the cold forming of the stem 200.

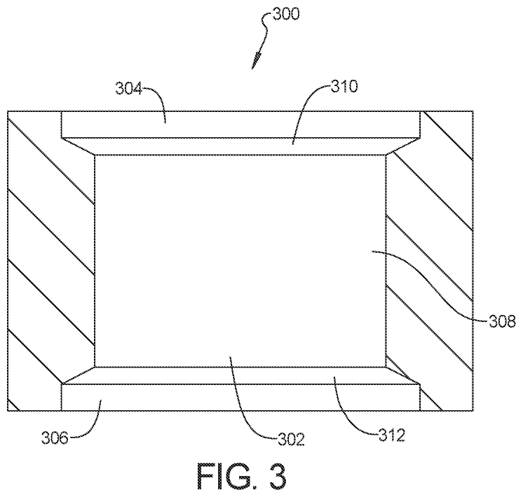

FIG. 3 is a side view of the sleeve 300. The sleeve 300 includes a central bore 302 that receives the stem 200. The central bore 302 has a first end (or portion or region) 304 and an opposing second end (or portion or region) 306, where the first end 304 has a diameter (D11) corresponding to, or for cooperation with, the lip 256 of the stem head 250, and the second end 306 has a diameter (D12) corresponding to, or for cooperation with, the locking skirt 272. The central bore 302 may have a middle section (or portion or region) 308 that extends between the first end 304 and the second end 306. The middle section 308 may have a diameter (D13) corresponding to, or for cooperation with, for example, under pressure, the waist 270 of the stem head 250, the first tapered portion 260 of the stem head 250, and the second tapered portion 262 of the stem head 250. In at least one example embodiment, the central bore 302 includes a first sloped (or tapered) portion (or section or region) 310 that extends between the first end 304 and the middle section 308. In at least one example embodiment, the central bore 302 includes a second sloped (or tapered) portion (or section or region) 312 that extends between the second end 306 and the middle section 308.

In at least one example embodiment, in an undeformed state, the first end 304 of the central bore 302 may have a diameter (D11) greater than or equal to about 7.4 millimeters to less than or equal to about 7.8 millimeters, optionally greater than or equal to about 7.47 millimeters to less than or equal to about 7.78 millimeters, and optionally greater than or equal to about 7.6 millimeters to less than or equal to about 7.65 millimeters. In at least one example embodiment, in an undeformed state, the second end 306 of the central bore 302 may have a diameter (D12) greater than or equal to about 7.4 millimeters to less than or equal to about 7.8 millimeters, optionally greater than or equal to about 7.47 millimeters to less than or equal to about 7.78 millimeters, and optionally greater than or equal to about 7.6 millimeters to less than or equal to about 7.65 millimeters. In at least one example embodiment, in an undeformed state, the middle section 308 of the central bore 302 may have a diameter (D13) greater than or equal to about 6 millimeters to less than or equal to about 6.4 millimeters, optionally greater than or equal to about 6.05 millimeters to less than or equal to about 6.36 millimeters, and optionally greater than or equal to about 6.18 millimeters to less than or equal to about 6.23 millimeters.

In at least one example embodiment, in an undeformed state, the sleeve 300 may have an outside diameter greater than or equal to about 9.7 millimeters to less than or equal to about 13.1 millimeters, optionally greater than or equal to about 9.74 millimeters to less than or equal to about 13.5 millimeters, optionally greater than or equal to about 9.87 millimeters to less than or equal to about 13 millimeters, and optionally about 12 millimeters, such that the sleeve 300 has a first thickness in the regions of the first and second ends 304, 306 of the central bore 302 and a second greater thickness in the region of the middle portion 308 of the central bore 302.

In at least one example embodiment, as illustrated in FIG. 3, the first and second ends 304, 306 of the sleeve 300 may be identical, allowing the sleeve 300 to be formed and placed without special considerations for orientation.

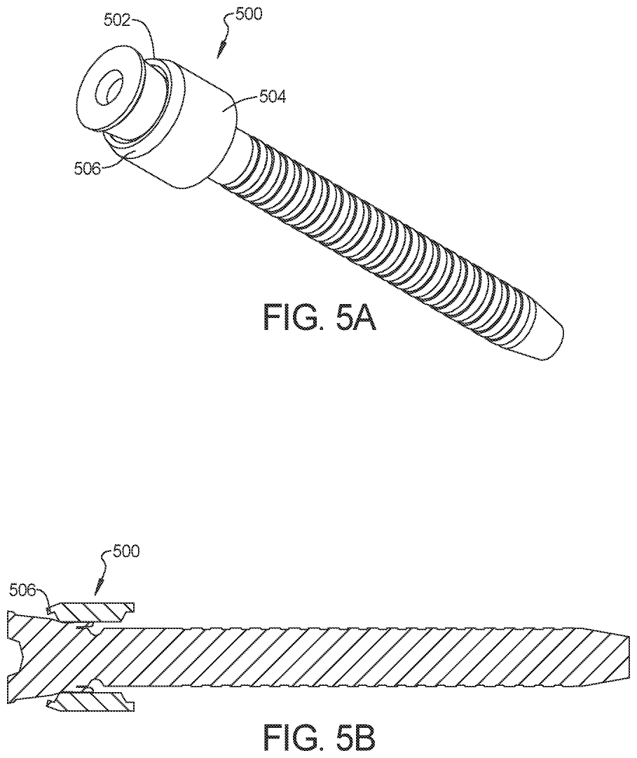

FIG. 5A is a perspective view of another example sealing plug including a sleeve member 500 that receives a stem member, like the stem member illustrated in FIG. 2, in accordance with at least one example embodiment of the present disclosure. FIG. 5B is a cross-sectional view of the example sealing plug illustrated in FIG. 5A. The sleeve 500 has a first end (or portion or region) 502 and an opposing section end (or portion or region) 504, where the second end 504 is difference from the first end 502. The sleeve 500 as illustrated in FIGS. 5A and 5B are the same as the sleeve 300 illustrated in FIGS. 1A, 1B, 3, and 4 except that the first end 502 of the sleeve 500 includes a tapered chamfered (or crimped) surface 506. In at least one example embodiment, the chamfered surface 506 may have about a 20 degree angle relative to a central axis of the sleeve 500. In at least one example embodiment, the chamfered surface 506 may have a length (L11) greater than or equal to about 1.2 millimeters to less than or equal to about 1.5 millimeters, optionally greater than or equal to about 1.3 millimeters to less than or equal to about 1.4 millimeters, and optionally about 1.33 millimeters. In at least one example embodiment, the length (L11) of the chamfered surface 506 may be greater than or equal to about 18% to less than or equal to about 24%, optionally greater than or equal to about 19% to less than or equal to about 23%, and optionally greater than or equal to about 19.35% to less than or equal to about 22.73%, of the length (L2) of the sleeve 500.

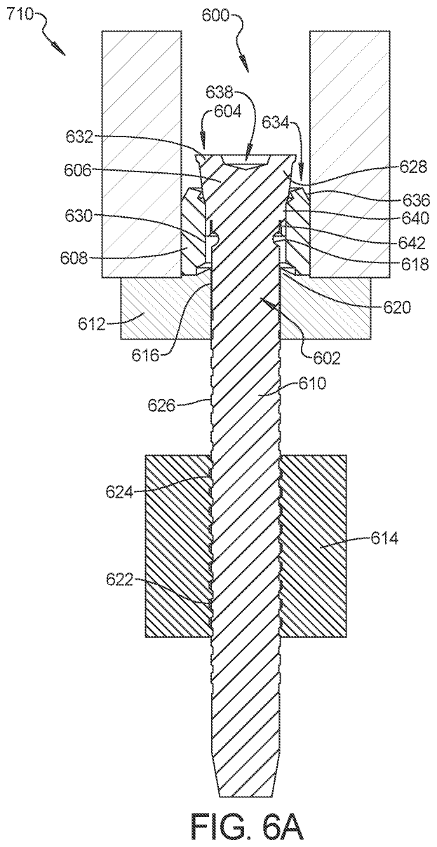

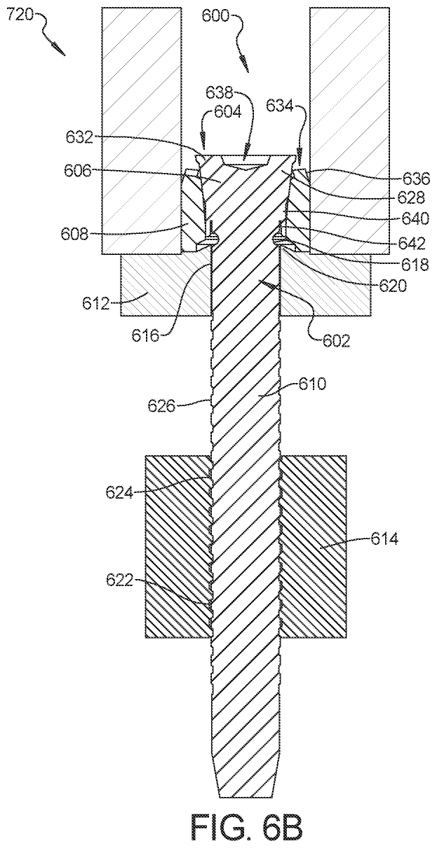

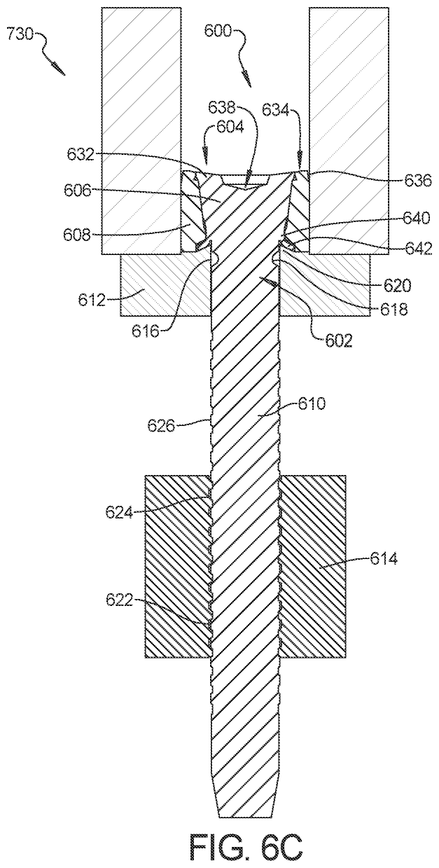

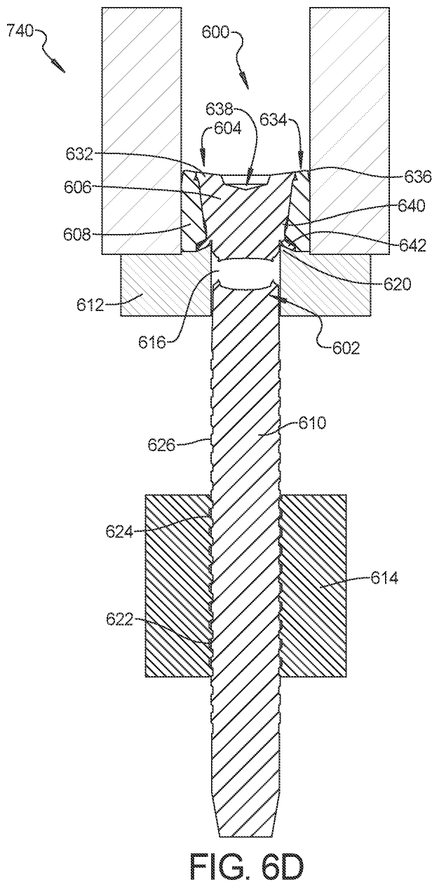

The chamfered surface 506 may help to provide guidance of the two-piece sealing plug into the sleeve 500 during placement. Further, the chamfered surface 506 may help to secure a two-piece sealing plug within a blind hole by forcing and locking the blind hole (e.g., blind hole 600 as detailed below in the instance of FIGS. 6A-6D) onto the waist of a stem head (e.g., the waist 270 of the stem head 250), which has the smallest diameter for the stem head (e.g., D9). Further still, the chamfered surface 506 may help the sleeve 300 form a mechanical seal around the lip 256.

FIGS. 6A-6D are cross-sectional views that illustrate a process for sealing a blind hole 600 using an example two-piece sealing plug 602 (including a stem, like the stem 200 illustrated in FIGS. 2 and 4 with the sleeve 300 illustrated in FIGS. 3 and 4 or the sleeve 500 illustrated in FIGS. 5A and 5B) in accordance with at least one example embodiment of the present disclosure.

The process for sealing the blind hole 600 may include, as illustrated at 710 in FIG. 6A, disposing (or placing or aligning) the two-piece sealing plug 602 within the blind hole 600. More particularly, a first end 604 of the two-piece sealing plug 602, including a stem head 606 and a sleeve 608 extending around a portion thereof, may be inserted into the blind hole 600. The stem head 606 and the sleeve 608 may be fully encompassed within the blind hole 600, while only a portion of a stem 610 connected to the stem head 606 is encompassed within the blind hole 600.

As illustrated, in at least one example embodiment, as would be appreciated by the skilled artisan, the two-piece sealing plug 602 may inserted using at least one of a nose tool (e.g., nose tip) 612 and a pulling tool (e.g., pulling jaws) 614. The nose tool 612 may have a cavity (or pocket) 616 that receives at least a first portion of the stem 610 near the stem head 606, including, for example, a breaker groove 618 that connects the stem head 606 and the stem 610. In at least one example embodiment, the nose tool 612 may also include a conical ring 620 that extends into the blind hole 600 once the two-piece sealing plug 602 is placed. The pulling tool 614 may include a cavity (or pocket) 622 that receives at least a second portion of the stem 610 away from the stem head 606. The pulling tool 614 may include corresponding threads 624 to engage threads 626 disposed along at least a portion of the stem 610. The two-piece sealing plug 602 may be inserted into the nose tool 612 and the pulling tool 614 using an automatic process or a manual process.

Once the sealing plug is disposed 710 within the blind hole, the process for sealing the blind hole 600 using the two-piece sealing plug 602 may include pulling (or reversing) the stem head 606 through the sleeve 608 as illustrated at 720, 730 in FIGS. 6B and 6C. The stem head 606 may be pulled through the sleeve 608 using the pulling tool 614 having the corresponding threads 624 with the stem 610 as connected to the stem head 606, as discussed above.

In at least one example embodiment, as the stem head 606 is pulled through the sleeve 608, a first tapered portion 628 of the stem head 606 may provide a main sealing action as it engages with the interior bore walls 630 of the sleeve 608. For example, the first tapered portion 628 may generate radial pressure against the interior bore walls 630 of the sleeve 608, where the radial pressure creates a mechanical seal that prevents fluid leaks through the sleeve 608.

In at least one example embodiment, the stem head 606 is pulled through the sleeve 608 until a lip 632 on an exterior end of the of the stem head 606 is fully engaged by sleeve 608, as further discussed above. In this manner, the lip 632 helps to arrest the stem head 606 from further movement through the sleeve 608 and thereby enhances the mechanical sealing between the stem head 606 and the sleeve 608 and prevent or limit leaks through the sealing plug 602.

In at least one example embodiment, the stem head 606 includes a counterbore 638 in a first surface, away from the stem 610. As illustrated, the counterbore 638 may allow for limited amount of deformation of the lip 632 as it is pulled into the sleeve 608 helping to further enhance the mechanical sealing between the stem head 606 and the sleeve 608 and prevent or limit leaks through the sealing plug 602.

In at least one example embodiment, a first end 634 of the sleeve 608, away from the stem 610, includes a chamfered surface 636 (like the sleeve 500 illustrated in FIGS. 5A and 5B). The first end 634 of the sleeve 608 may be the same as the first end 604 of the sealing plug 602. As further discussed above, in at least one example embodiment, the chamfered surface 636 may help further enhance the mechanical sealing between the stem head 606 and the sleeve 608 and prevent or limit leaks through the sealing plug 602

In at least one example embodiment, the stem head 606 further includes a waist 640 and a skirt 642 (like the waist 270 and the skirt 272 of the stem 200 illustrated in FIGS. 2 and 4). As illustrated in FIGS. 6B and 6C, material (like the conical ring 620 of the nose tool 612) can flow between a body of the stem head 606 and the skirt 242 (or flap thereof). In at least one example embodiment, the skirt 642 may thereby prevent or limit stem break-point protrusion and/or to help prevent or limit the effects of recoil during breakage or disassociation, as further discussed above.

Once the sealing plug is sealed 720, 730 within the blind hole, the process for sealing the blind hole 600 using the two-piece sealing plug 602 may include causing, or allowing breakage or dissociation between the stem 610 and the stem head 606, as illustrated at 740 in FIG. 6D.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sealing plug for blind hole, one-sided installation, the sealing plug comprising:
a stem including:
a stem body, and
a stem head including a first portion and a second portion,
the first portion being a tapered portion having a first diameter, a second diameter that is less than the first diameter, and a first sloped portion therebetween, and
the second portion having a third diameter that is less than the first and second diameters; and
a sleeve that surrounds at least a portion of the stem head.

2. The sealing plug of claim 1, wherein
the first portion is a first tapered portion,
the stem head further includes a second tapered portion between the first tapered portion and the second portion, and
the second tapered portion has a fourth diameter, a fifth diameter that is less than the fourth diameter, and a second sloped portion therebetween.

3. The sealing plug of claim 2, wherein
the stem head has a first length,
the first tapered portion has a second length greater than or equal to about 36% to less than or equal to about 44% of the first length,
the second portion has a third length greater than or equal to about 7% to less than or equal to about 14% of the first length, and
the second tapered portion has a fourth length greater than or equal to about 11% to less than or equal to about 16% of the first length.

4. The sealing plug of claim 2, wherein the third diameter is less than each of the first diameter, the second diameter, and the fourth diameter, and the third diameter is the same as fifth diameter.

5. The sealing plug of claim 1, wherein
the stem head includes a first end and an opposing second end,
the second end of the stem head is disposed nearer to the stem body than the first end of the stem head,
the stem head including a lip member disposed at the first end of the stem head and connected to the first portion, and
the lip member has a fourth diameter greater than a remainder of the stem head, the remainder of the stem head including the first portion and the second portion.

6. The sealing plug of claim 1, wherein
the stem head includes a first end and an opposing second end,
the second end of the stem head is disposed nearer to the stem body than the first end of the stem head,
the stem head including a skirt member disposed at the second end of the stem head and connected to the second portion,
the skirt member has a flap separated from a body of the stem head,
and the flap extends around at least a portion of the second end of the stem head.

7. The sealing plug of claim 1, wherein the sleeve has a first length greater than or equal to about 13.7% to less than or equal to about 14.5% of a second length of the stem.

8. The sealing plug of claim 1, wherein the sealing plug is an all-aluminum sealing plug, the stem and sleeve each including an aluminum alloy.

9. The sealing plug of claim 8, wherein at least one of the stem and the sleeve includes aluminum grades 6061, 3103, 7075, or any combination thereof.

10. The sealing plug of claim 1, wherein the stem has a first hardness that is greater than a second hardness of the sleeve, and the sleeve has a first ductility that is greater than a second ductility of the stem.

11. The sealing plug of claim 1, wherein
the stem body has a fourth diameter that is less than the third diameter,
the stem further includes a breaker groove between the stem head and the stem body, and
the breaker groove has a fifth diameter that is less than the both the third diameter and the fourth diameter.

12. The sealing plug of claim 1, wherein
the sleeve has a central bore having a first section, a second section, and a middle section disposed therebetween,
the first section has a fourth diameter,
the second section has a fifth diameter that is the same as or different from the fourth diameter, and
the middle section has a sixth diameter that is greater than both the fourth diameter and the fifth diameter.

13. The sealing plug of claim 12, wherein
the sleeve has a first end and an opposing section end,
the second end of the sleeve is disposed nearer to the stem body than the first end of the sleeve,
the sleeve has a chamfered portion disposed at the first end of the sleeve, and
the chamfered portion being angled inward toward the central bore of the sleeve.

14. The sealing plug of claim 13, wherein the chamfered portion has a first length that is greater than or equal to about 18% to less than or equal to about 24% of a second length of the sleeve.

15. The sealing plug of claim 1, wherein the stem body includes a plurality of threads, the plurality of threads extending along greater than or equal to about 60% to less than or equal to about 95% of a length of the stem body.

16. The sealing plug of claim 15, wherein
the first portion is a first tapered portion,
the stem body has a first end and an opposing second end,
the first end of the stem body is disposed nearer to the stem head than the second end of the stem body,
the stem body includes a first thread-free portion disposed at the first end of the stem body and a second thread-free portion disposed at the second end of the stem body, and
the second thread-free portion is a second tapered portion that includes a fourth diameter, a fifth diameter that is less than the fourth diameter, and a second sloped portion therebetween.

17. The sealing plug of claim 1, wherein the stem head has a first length greater than or equal to about 15% to less than or equal to about 18% of a second length of the stem body.

18. A stem head for using in sealing plug for blind hole, one-sided installation, the stem head having a first end and an opposing second end, the stem head comprising:
a lip member disposed at the first end and having a first diameter,
a skirt member disposed at the second end and have a second diameter that is less than the first diameter, and
a tapered portion disposed between the lip member and the skirt member and having a third diameter, a fourth diameter that is less than the third diameter, and a first sloped portion therebetween, the third and fourth diameters being less than the first diameter and greater than the second diameter.

19. The sealing plug of claim 18, wherein
the tapered portion is a first tapered portion,
the stem head further includes a second tapered portion between the first tapered portion and the skirt member,
the second tapered portion has a fifth diameter, a sixth diameter that is less than the fifth diameter, and a second sloped portion therebetween, the fifth and sixth diameters being less than the third and fourth diameter and greater than the second diameter.

20. The sealing plug of claim 19, wherein
the stem head further includes a waist member between the second tapered portion and the skirt member,
the waist member having a seventh diameter that is same as the second diameter.
